(19) United States
(12) Patent Application Publication
(10) Pub. No.: US 2024/0391358 A1
(43) Pub. Date: Nov. 28, 2024

(54) VEHICLE OCCUPANCY DETECTION

(71) Applicant: Analog Devices International Unlimited Company, Limerick (IE)

(72) Inventors: Dietmar RUWISCH, Berlin (DE); Andrew James McLean, Prides Corner, MA (US)

(21) Appl. No.: 18/321,466

(22) Filed: May 22, 2023

(51) Int. Cl. B60N 2/00; B60Q 5/00

(52) U.S. Cl. CPC B60N 2/002; B60Q 5/00

(57) ABSTRACT

An apparatus and methods for detecting seat occupancy of a vehicle including a plurality of seats, one or more microphones, and one or more loudspeakers are described. The apparatus in the vehicle includes a digital signal processor coupled to a memory and configured to: determine a first set of transfer functions between the one or more microphones and the one or more loudspeakers based on a first audio signal played from the one or more loudspeakers while passengers are occupying one or more of the plurality of seats. The digital signal processor is configured to apply at least the first set of transfer functions and a second set of transfer functions for the vehicle to a neural network trained on transfer functions for a type of the vehicle to predict a seat occupancy of each of the plurality of seats based on the transfer functions.

### TECHNICAL FIELD

This disclosure is related to vehicle occupancy detection, and more particularly to vehicle occupancy detection using audio signals.

### INTRODUCTION

Knowledge about the occupancy of a vehicle is important for various safety mechanisms of a vehicle. For example, vehicle occupancy may be used for adaptation of impact mitigation systems (e.g., airbags) or forgotten child reminders. In order for a vehicle to perform these operations, the vehicle must detect the occupancy of passengers in the seats of the vehicle.

Various systems for vehicle occupancy detection have been proposed. For example, detection using weight sensors, infrared sensors, ultrasound, and various radio waves such as ultra-wideband keyless entry and frequency modulated continuous wave (FMCW) radar have been proposed. While each of these systems has various strengths for detecting passengers within a vehicle, they all share a common factor of additional specialized hardware such as sensors installed in the vehicle. Accordingly, a vehicle occupancy detection system that does not require additional specialized hardware would be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a method of detecting seat occupancy of a vehicle including a plurality of seats, one or more microphones, and one or more loudspeakers, including: determining a first set of transfer functions between the one or more microphones and the one or more loudspeakers based on a first audio signal played from the one or more loudspeakers while passengers are occupying one or more of the plurality of seats; and applying at least the first set of transfer functions and a second set of transfer functions for the vehicle to a neural network trained on transfer functions for a type of the vehicle to predict a seat occupancy of each of the plurality of seats based on the transfer functions.

In some aspects, the techniques described herein relate to a method of training a neural network to detect vehicle occupancy of a vehicle including a plurality of seats, one or more microphones, and one or more loudspeakers, including: playing, in the vehicle, an audio signal via the one or more loudspeakers while the plurality of seats are in each occupied condition of a plurality of occupied conditions including an empty-vehicle condition; recording, by the one or more microphones, a respective received audio signal for each of the one or more loudspeakers for each occupied condition; calculating a set of transfer functions between each pair of loudspeaker and microphone for each occupied condition; and training a neural network to predict an occupancy for each of the plurality of seats based on a first set of transfer functions for the empty-vehicle condition and a second set of transfer functions for a current occupied condition.

In some aspects, the techniques described herein relate to an apparatus for detecting seat occupancy of a vehicle including a plurality of seats, one or more microphones, and one or more loudspeakers, including: a memory storing computer-executable instructions; and a digital signal processor coupled to the memory and configured to execute the instructions to: determine a first set of transfer functions between the one or more microphones and the one or more loudspeakers based on a first audio signal played from the one or more loudspeakers while passengers are occupying one or more of the plurality of seats; and apply at least the first set of transfer functions and a second set of transfer functions for the vehicle to a neural network trained on transfer functions for a type of the vehicle to predict a seat occupancy of each of the plurality of seats based on the transfer functions.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

To provide a more complete understanding of the present disclosure and features and advantages thereof, reference may be made to the following description, taken in conjunction with the accompanying figures, wherein like reference numerals represent like parts, in which:

FIG. 1 is a diagram of an example vehicle including an audio processing unit that implements a vehicle occupancy detection component.

FIG. 2 is a conceptual diagram of the vehicle occupancy detection component.

FIG. 3 is a logical flowchart of an example method of collecting training data for training an artificial neural network.

FIG. 4 is a logical flowchart of an example method of training the artificial neural network.

FIG. 5 is a flowchart of an example method for detecting vehicle occupancy.

FIG. 6 is a flowchart of another example method of training a neural network to detect vehicle occupancy of a vehicle.

FIG. 7 is a flowchart of another example method of detecting vehicle occupancy.

### DETAILED DESCRIPTION

Conventional vehicle occupancy detection uses pressure sensors in every seat. Such systems may detect passengers, but may also generate false positives based on other objects placed on a seat. The pressure sensors also add component cost and complexity to the vehicle. Alternative vehicle occupancy detection systems using infrared, ultrasound, or radio frequency (including radar) require additional emitters and sensors to be added to a vehicle. There may also be concern that additional electro-magnetic radiation in a vehicle may interfere with other systems and/or have an effect on passengers.

Passenger vehicles are usually equipped with an entertainment system including a plurality of loudspeakers. Additionally, microphones are typically included in a vehicle to provide hands-free applications for voice control of some vehicle systems such as entertainment, telephone, or navigation. Such voice control systems implement acoustic echo cancelling for the hands-free applications, where it is known that transfer-functions between loudspeakers and microphone(s) change with the passenger-load of the vehicle (and the temperature).

In an aspect, the present disclosure provides systems and methods for detecting vehicle occupancy by applying machine-learning to transfer functions between vehicle loudspeakers and microphones. The transfer functions are calculated from audio signals played through loudspeakers and being picked up by one or more microphones in the vehicle. Because the microphones and loudspeakers are standard components that every vehicle is equipped with, no additional acoustic hardware is required. A machine-learning model such as a neural network may be trained to predict an occupancy status of each seat in the vehicle based on sets of transfer functions. The machine-learning model can be pre-trained for the type of vehicle. For example, the machine-learning model may be applicable to all vehicles of the same model. In some cases, variations of model that affect seating (e.g., optional third row seating) may use separate pre-trained models.

In some implementations, transfer functions may be affected by properties other than vehicle occupancy. For example, temperature is known to affect the transfer function. Additionally, individual properties of the acoustic components (loudspeakers and microphones and their tolerances) influence the transfer functions, too. In some implementations, the machine-learning model may account for such properties. For example, the machine-learning model may be trained based on a first set of transfer functions measured when the vehicle is empty and a second set of transfer functions when the vehicle is occupied. For instance, a training set and/or feature vector of the machine-learning model may include a difference between the first set of transfer functions and the second set of transfer functions. Accordingly, the machine-learning model is trained on and evaluates a change in the transfer function rather than the transfer function itself. In some implementations, the second set of transfer functions for the empty vehicle is measured shortly before the vehicle is occupied (e.g., when the vehicle is unlocked). In some implementations, the feature vector may also include a current temperature to account for the effects of temperature change.

In some implementations, the present disclosure describes a method of training a neural network to detect vehicle occupancy of a vehicle including a plurality of seats, one or more microphones, and one or more loudspeakers. The method includes playing, in the vehicle, an audio signal via the one or more loudspeakers while the plurality of seats are in each occupied condition of a plurality of occupied conditions including an empty-vehicle condition. The method includes recording, by the one or more microphones, a respective received audio signal for each of the one or more loudspeakers for each occupied condition. The method includes calculating a set of transfer functions between each pair of loudspeaker and microphone for each occupied condition. The method includes training a neural network to predict an occupancy for each of the plurality of seats based on a first set of transfer functions for the empty-vehicle condition and a second set of transfer functions for a current occupied condition.

In an aspect, the present disclosure may provide one or more of the following technical benefits. The techniques disclosed herein provide for vehicle occupancy detection using microphones and loudspeakers, and can be performed by a digital signal processor of the vehicle, thereby reducing need for dedicated emitters or sensors and the associated costs. Additionally, the disclosed techniques may be used in combination with any additional sensors to verify vehicle occupancy. In some implementations, although the machine-learning model is pre-trained for a type of vehicle (e.g., model), the inputs (e.g., a feature vector) account for changes in component properties and environmental factors based on recent measurements for an empty vehicle. Accordingly, the same machine-learning model can be applied to different vehicles of the same type without individual training.

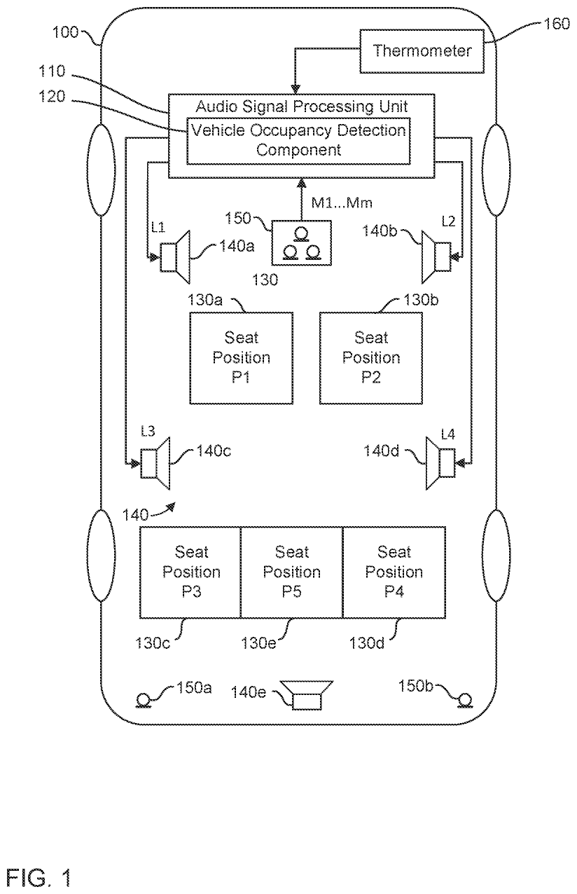

FIG. 1 is a diagram of an example vehicle 100 including an audio processing unit 110 that implements a vehicle occupancy detection component 120. The vehicle 100 may be any type of passenger vehicle such as an internal combustion engine (ICE) vehicle, an electric vehicle (EV), or a hybrid vehicle. The vehicle 100 includes a plurality of seats 130. The seats 130 may be arranged into one or more rows. For example, a seat 130a and 130b may be in a front row for the driver and front seat passenger, and the seats 130c, 130d, and 130e may be in a second row. The vehicle 100 may include additional seats or rows. In some implementations, a type of vehicle may be a model that has seats (and other cabin structures) in a known configuration. In some implementations, different seating configuration options (e.g., optional seats or folding seats) may be considered a different type of vehicle or use a different machine-learning model for each seat configuration.

The vehicle 100 includes one or more loudspeakers 140. Each loudspeaker 140 may be capable of outputting sound based on a received audio signal. For example, the loudspeakers 140 may be part of an entertainment system of the vehicle 100. For instance, as illustrated, the loudspeakers 140a, 140b, 140c, and 140d may be arranged around the seats 130. In some implementations, a loudspeaker 140e that is external to an entertainment system may be used for occupancy detection. The loudspeakers 140 are configured to output sounds within a frequency band based on a loudspeaker audio signal, L. The loudspeaker audio signal may be represented as L1 . . . Ln for n loudspeakers. For example, the frequency band may be approximately 250 Hz-12 kHz. The frequency band may be within a range of human hearing. The loudspeakers 140 may not be capable of producing ultrasonic signals.

The vehicle 100 includes one or more microphones 150. For example, the microphones 150 may be arranged in a microphone array. Each microphone 150 may record a separate received audio signal, M. The received audio signals may be represented as M₁ . . . Mₘ. In some implementations, the microphones 150 may be arranged in an array, for example, where the microphones are also used for voice control. In some implementations, microphones 150a and/or 150b may be placed in strategic locations (e.g., behind seats 130) to aid in occupancy detection. Further, the received audio signals may be associated with one of the loudspeakers. Accordingly, a received audio signal may be represented in the form M_{m,n} indicating the signal received at the m^{th} microphone from the n^{th} loudspeaker. When multiple sets of received audio signals are collected, the sets may be represented in the form M_{X,m,n}, where X is the set (e.g., corresponding to a vehicle occupancy condition).

In some implementations, the vehicle includes a thermometer 160. The thermometer 160 may measure a current temperature within a vehicle cabin and provide a temperature signal, T, to the audio signal processing unit 110. The temperature may affect the transfer-function of the audio signals (e.g., due to associated changes in air pressure).

In an aspect, a transfer function may represent a change from the loudspeaker audio signal, L, output by a loudspeaker 140 to the received audio signal, M, received by a microphone 150. In some implementations, a set of transfer functions may include transfer functions for each pair of loudspeaker 140 and microphone 150. Further, a transfer function may be analyzed over a frequency band. For example, the frequency band of approximately 250 Hz-12 kHz may be sampled with a frequency resolution of 50-150 Hz to generate the transfer function. Other frequency bands within a range of human hearing and/or producible by the loudspeakers 140 may be used.

In an aspect, in order to provide robust measurements of the transfer functions, the audio signal processing unit 110 may play loudspeaker audio signals, L, via the loudspeakers 140 and record corresponding received audio signals. M, via the microphones 150. In an aspect, the vehicle occupancy detection may be based on a difference in transfer functions when the vehicle is empty to when the vehicle is occupied. Because the transfer function for an empty vehicle may vary between individual vehicles (e.g., based on individual audio components) and based on temperature, measurement of the transfer function of the empty vehicle may be performed shortly before the vehicle is loaded. In some implementations, unlocking the audio signal processing unit 110 may play the loudspeaker audio signals L in response to the vehicle 100 being unlocked in order to generate a fresh transfer function for the empty vehicle.

In some implementations, the loudspeaker audio signal L is an engineered audio signal designed to span the frequency band. For instance, the loudspeaker audio signal L may be a chime or chirp that changes in frequency. In some implementations, the audio signal processing unit 110 may play the loudspeaker audio signal L from each of the loudspeakers 140 individually. Each individual loudspeaker audio signal L may be a fraction of a second. In some implementations, the loudspeaker audio signal may be another audio signal output by the vehicle entertainment system. For instance, the loudspeaker audio signal may be music or conversation output by the entertainment system. Where the individual loudspeaker audio signals L do not overlap in time, each received audio signal may correspond to only one loudspeaker 140 and transfer function can be calculated directly from the measured signals. In some implementations, the loudspeaker audio signals L may not be separated in time. The audio signal processing unit 110 may decorrelate the loudspeaker audio signals L, for example, using different frequencies. For instance, each loudspeaker may play a different frequency range such that the received audio signals M are different for each loudspeaker.

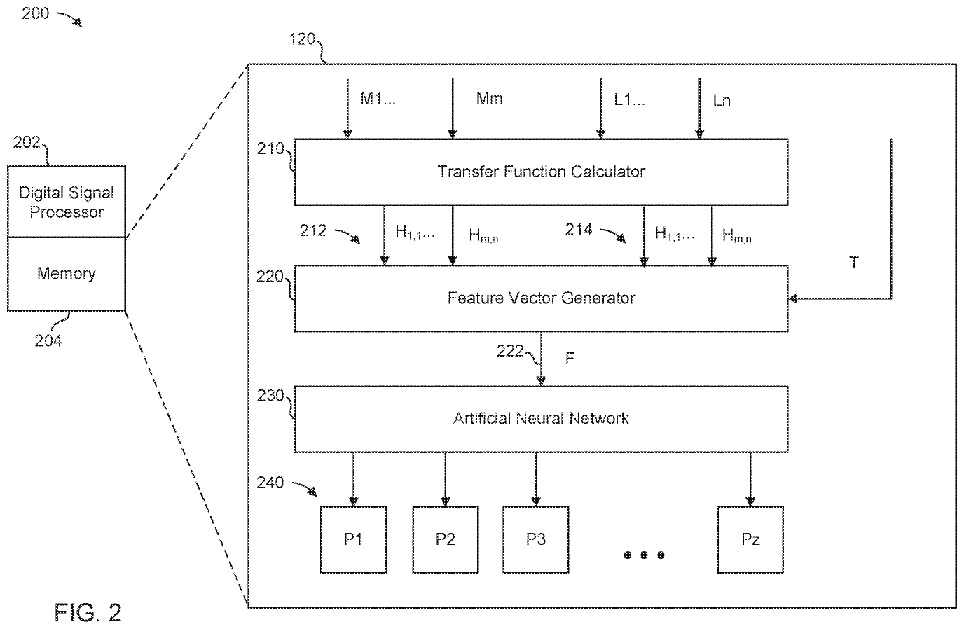

FIG. 2 is a conceptual diagram 200 of the vehicle occupancy detection component 120. In some implementations, the vehicle occupancy detection component 120 may be implemented on a digital signal processor 202 and associated memory 204. The memory 204 may store computer-executable instructions defining the vehicle occupancy detection component 120. The digital signal processor 202 may execute the computer-executable instructions. The vehicle occupancy detection component 120 may include a transfer function calculator 210, a feature vector generator 220, and an artificial neural network 230.

The transfer function calculator 210 may be configured to calculate a set of transfer functions H based on the loudspeaker audio signals L and the microphone audio signals M. The transfer function calculator 210 may obtain the loudspeaker audio signals L from the audio signal processing unit 110 as the loudspeaker audio signals L are output to the loudspeaker 140. The transfer function calculator 210 may obtain the microphone audio signal M as input from the microphones 150. The transfer functions H are complex-valued functions of the audio frequency. For example, transfer functions are described in, for example, U.S. Pat. No. 6,683,961. A set of transfer functions may include a transfer function for each pair of microphone signal M and loudspeaker signal L. For example, the transfer function H_{1,1} is the transfer function between a first loudspeaker (e.g., loudspeaker 140a) and a first microphone 150. The vehicle 100 may include m loudspeakers and n microphones for a total of m×n transfer functions. In an aspect, the transfer function calculator 210 may calculate a first set of transfer functions 212 for an occupancy condition while passengers are present in the vehicle and a second set of transfer functions 214 for an empty-vehicle occupancy condition.

The feature vector generator 220 is configured to generate a feature vector F 222 based on a first set of transfer functions 212 and a second set of transfer functions 214. The feature vector generator 220 outputs the feature vector F 222 to the artificial neural network 230. The transfer function calculator 210 may output the first set of transfer functions 212 for an occupied condition. For instance, the first set of transfer functions 212 may be measured once the vehicle doors have locked and the vehicle 100 is started. The transfer function calculator 210 may output the second set of transfer functions 214 for an empty vehicle. In some implementations, the transfer function calculator 210 measures the second set of transfer functions just prior to loading the vehicle 100, for example, when the vehicle 100 is unlocked. In other implementations, the feature vector generator 220 may store a previously generated second set of transfer functions 214 for the empty vehicle condition. In some implementations, the feature vector generator 220 also receives a temperature, T, from the thermometer 160. The temperature T may be associated with the first set of transfer functions 212 and/or the second set of transfer functions 214. For instance, the internal temperature of the vehicle 100 may change significantly when the doors are opened and passengers are loaded, so a temperature associated with each set of transfer functions may improve prediction by accounting for changes due to temperature change rather than change in seat occupancy.

In some implementations, the feature vector F 222 includes both the first set of transfer functions 212 and the second set of transfer functions 214. For instance, the feature vector F may simply be a concatenation of the first set of transfer functions and the second set of transfer functions. In some implementations, the feature vector F may include a difference in magnitude between corresponding pairs of the first set of transfer functions and the second set of transfer functions at a plurality of frequencies within an analyzed frequency band. For instance, the feature vector generator 220 may sample the transfer functions at each of the plurality of frequencies to generate a vector, then subtract the vectors to determine the difference in magnitude. The feature vector F 222 may optionally include a single temperature, or a temperature associated with each set of transfer functions.

The artificial neural network 230 is configured to predict a seat occupancy 240 for each of the plurality of seats 130 based on the feature vector F 222. The artificial neural network 230 is trained based on training sets including feature vectors that have been labeled with the correct seat occupancy 240. In some implementations, the seat occupancy 240 is a binary or Boolean value indicating whether the corresponding seat 130 is occupied. For example, 0 may indicate unoccupied and 1 may indicate occupied. In some implementations, the seat occupancy 240 is an indication of a size of an occupant in the corresponding seat 130. For example, 0 may indicate unoccupied and 1 may indicate occupied by an adult, but a value of 0.25 may indicate an infant or toddler whereas a value of 0.75 may indicate a child. Where such continuous values are used, the value may correspond to a size (e.g., using weight as an approximation) of the occupant. The artificial neural network 230 may output the predicted seat occupancy 240 to one or more system of the vehicle such as a collision mitigation system or child reminder system.

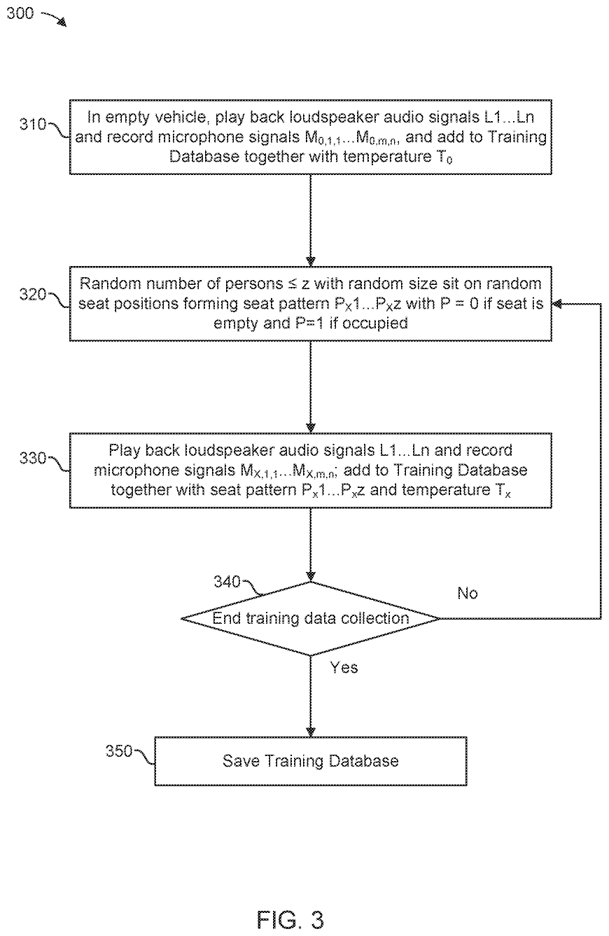

FIG. 3 is a logical flowchart of an example method 300 of collecting training data for training the artificial neural network 230. In an aspect, the method 300 may be performed by an external computer in communication with the audio signal processing unit 110 including the vehicle occupancy detection component 120. For instance, the audio signal processing unit 110 and/or the vehicle occupancy detection component may be placed in a training mode or connected to the external computer to control the training process and store a training database.

Training data acquisition starts at block 310 in the empty vehicle with recording m microphone signals M0_{1,1} . . . M0_{m,n} while n loudspeakers output audio signals L1 . . . Ln. For instance, the loudspeaker signals may be suitably composed chimes or jingles. An example of such chime or jingle includes chirps being played by one loudspeaker after the other. The recorded microphone signals are added to a training database. Optionally, the current in-cabin air temperature is associated with the recorded microphone signals.

Next, at block 320, one or more people of different size enter the vehicle on random seat positions of the z car seats. In the resulting seat pattern P_{X}1 . . . P_{X}z, 0 means seat is empty, 1 means seat is occupied. The resulting seat pattern is recorded for labeling a training set.

After doors are closed, at block 330, the loudspeakers 140 play signals L1 . . . Ln. Preferably, the signals L1 . . . Ln are the same as in block 310. The audio signal processing unit 110 records the microphone signals M_{x,1,1} . . . M_{X,m,n} to the training database. Optionally, the in-cabin air temperature Tₓ is associated with the set of training data including the loudspeaker signals L1 . . . Ln and the microphone signals M_{X,1,1} . . . M_{x,m,n} labeled with the seat pattern Pₓ1 . . . Pₓz.

At decision block 340, if training data collection is complete, the method 300 proceeds to block 350 where the training database is saved. If the training data collection is not complete, blocks 320, 330, and 340 are repeated.

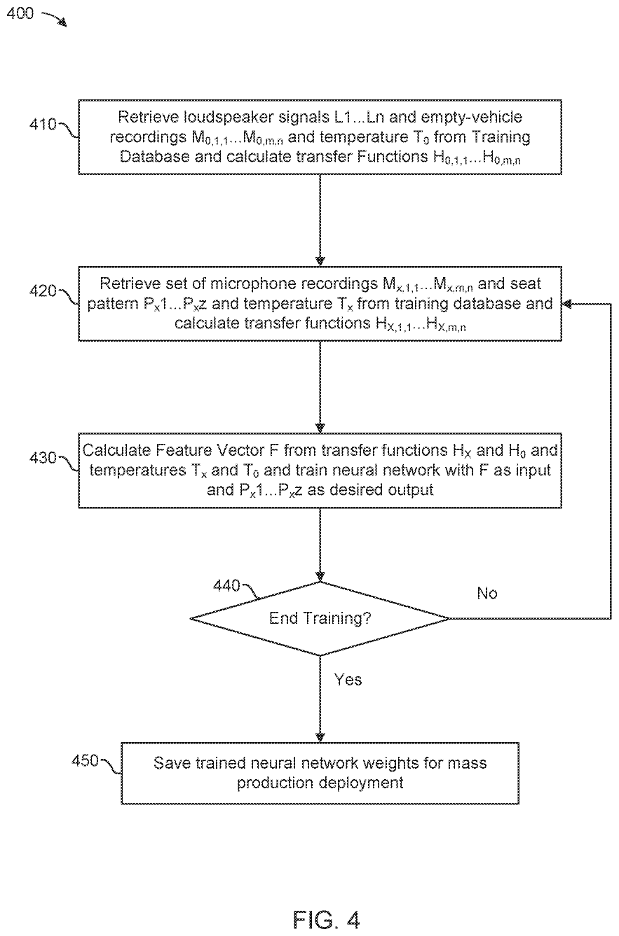

FIG. 4 is a logical flowchart of an example method 400 of training the artificial neural network 230. The training phase converts the entries of the training database into weights of the artificial neural network 230 with a state-of-the-art machine-learning training algorithm. For example, the training algorithm may utilize backpropagation. The method 400 may be performed by an external computer. For instance, the external computer may include hardware adapted for machine-learning such as a neural net processor or graphics processing unit (GPU), or may be a personal computer, server, or cloud network that utilizes generic computing resources. The method 400 may be performed on a training database with training sets collected from a specific type of vehicle (e.g., model) and may generate a trained neural network for the same type of vehicle. For instance, the trained neural network may be loaded onto the vehicle occupancy detection component 120 as the artificial neural network 230 prior to delivery. Alternatively, the trained neural network may be loaded as an update either at a service appointment or over the air via a telecommunications system of the vehicle 100.

At block 410, an empty-vehicle dataset is retrieved from the training database, and for pairs of the m microphones and n loudspeakers transfer functions H_{0,m,n}(f) are calculated as complex-valued functions of the audio frequency, f. For example, the training phase may utilize the same algorithm for calculating the transfer functions as the transfer function calculator 210.

At block 420 a data set, X, with one or more seats being occupied is retrieved from the training database, and transfer functions H_{X,m,n} are calculated from the recordings M_{X,1,1} . . . M_{X,m,n} and L1 . . . Ln, accordingly.

At block 430, a feature vector F is calculated as input to the neural network, with which it is trained to predict the seat pattern Pₓ1 . . . Pₓz. e.g., the components of the feature vector are the magnitude-differences of H_{X,m,n}(f) and H_{0,m,n}(f) at each frequency f within the analyzed frequency band, e.g., 250 Hz-12 kHz with a frequency resolution of e.g., 125 Hz. In some implementations, the Feature Vector F optionally includes temperature data.

At decision block 440, if the training phase ends, the method 400 proceeds to block 450 where the trained weights of the artificial neural network 230 are saved for later usage in production. Otherwise, the method 400 repeats blocks 420, 430, and 440.

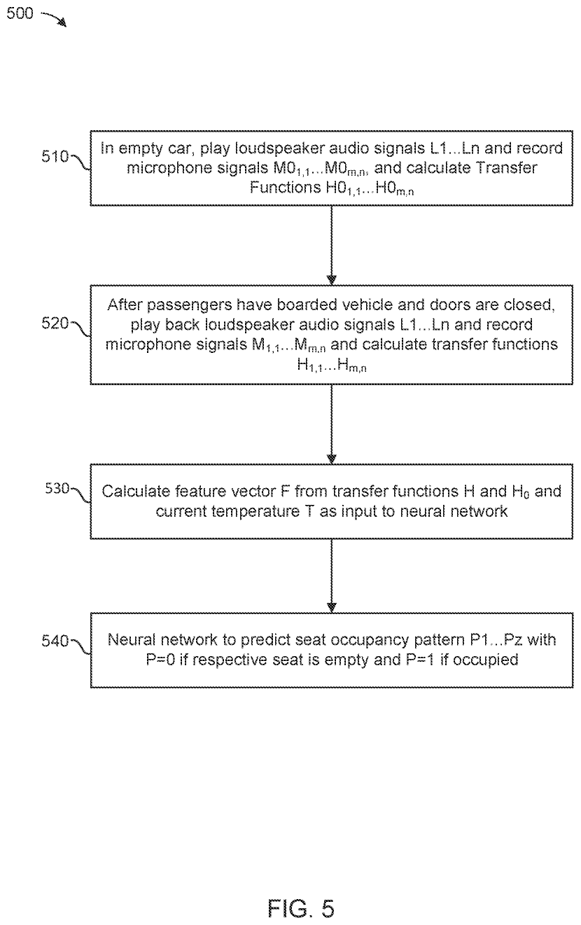

FIG. 5 is a flowchart of an example method 500 for detecting vehicle occupancy. The method 500 may be performed by the audio signal processing unit 110 including the vehicle occupancy detection component 120. For vehicle operation, the trained weights of the artificial neural network 230 are used to predict the vehicle occupancy, i.e., the seat occupancy 240 for each seat.

At block 510, before vehicle doors are opened, the audio signal processing unit 110 plays loudspeaker signals L1 . . . Ln and records microphone signals M_{0,1,1} . . . M_{0,m,n} in the empty vehicle. The block 510 may be similar to the block 310, but performed when the vehicle is in use.

At block 520, after the vehicle is boarded and doors are closed, audio signal processing unit 110 again plays loudspeaker signals L1 . . . L, and records microphone signals M_{0,1,1} . . . M_{0,m,n}.

At block 530, the vehicle occupancy detection component 120 and/or the feature vector generator 220 calculates the feature vector F 222 from the previously acquired recordings. Depending on the implementation and training of the artificial neural network 230, as described in block 430, the in-cabin air temperature may optionally be included in the feature vector F 222.

At block 540, with feature vector F 222 as input, the artificial neural network 230 predicts the seat occupancy pattern. The artificial neural network 230 may output the seat occupancy 240 for each seat 130 (e.g., P1 . . . Pz). In some implementations, the seat occupancy 240 may indicate being occupied or not (P=0 or 1). In other implementations, values of the seat occupancy 240 between 0 and 1 may indicate a prediction of smaller persons, children, baby seats, or bags on a seat 130.

In some implementations, blocks 520, 530, and 540 can be repeated anytime during vehicle operation to confirm the seat occupancy pattern.

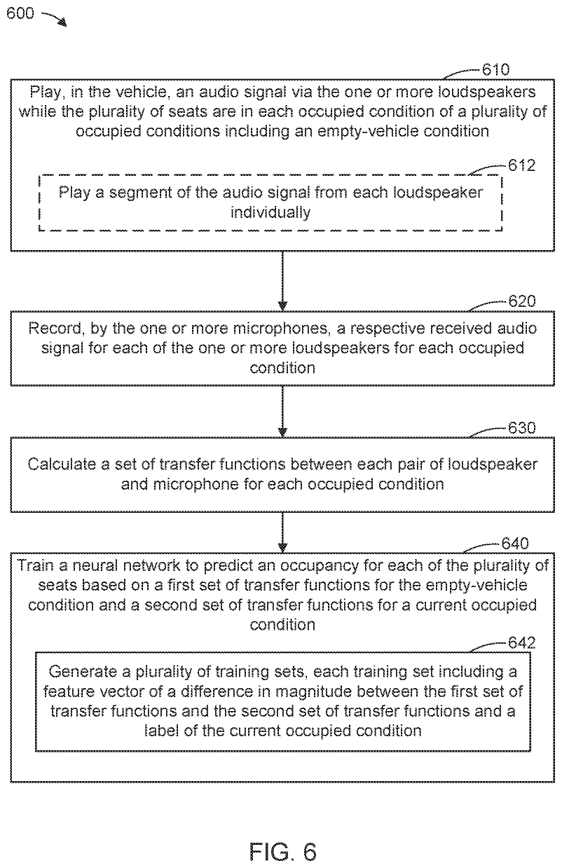

FIG. 6 is a flowchart of another example method 600 of training a training a neural network to detect vehicle occupancy of a vehicle. The method 600 may provide the artificial neural network 230, which may be used in a vehicle including a plurality of seats, one or more microphones, and one or more loudspeakers.

In block 610, the method 600 includes playing, in the vehicle, an audio signal via the one or more loudspeakers while the plurality of seats are in each occupied condition of a plurality of occupied conditions including an empty-vehicle condition. For example, in some implementations, the audio signal processing unit 110, under control of the vehicle occupancy detection component 120 and/or an external computer, plays the loudspeaker audio signals L1 . . . Ln while the plurality of seats 130 are in each occupied condition of a plurality of occupied conditions including an empty-vehicle condition. In some implementations, the plurality of occupied conditions may be randomly selected. In some implementations, the plurality of occupied conditions may include each combination of seats for up to z passengers (i.e., one in each seat). In some implementations, at sub-block 612, the block 610 optionally includes playing a segment of the audio signal from each loudspeaker 140 individually.

In block 620, the method 600 includes recording, by the one or more microphones, a respective received audio signal for each of the one or more loudspeakers for each occupied condition. For instance, in some implementations, the one or more microphones 150 record a respective received audio signal (M_{1,1} . . . M_{m,n}) for each of the n loudspeakers 140 for each occupied condition X.

In block 630, the method 600 includes calculating a set of transfer functions between each pair of loudspeaker and microphone for each occupied condition. For example, in some implementations, the transfer function calculator 210 calculates a set of transfer functions H_{1,1} . . . H_{m,n} between each pair of loudspeaker 140 and microphone 150 for each occupied condition X. In some implementations, each set of transfer functions is further associated with a current temperature and the feature vector further includes the current temperature.

In block 640, the method 600 includes training a neural network to predict an occupancy for each of the plurality of seats based on a first set of transfer functions for the empty-vehicle condition and a second set of transfer functions for a current occupied condition. In some implementations, for example, the digital signal processor 202 or an external computer may train the artificial neural network 230 to predict an occupancy for each of the plurality of seats 130 based on a first set of transfer functions 212 for the empty-vehicle condition and a second set of transfer functions 214 for a current occupied condition. In some implementations, the neural network is configured to output an estimate of a size of a person occupying each of the plurality of seats.

In some implementations, at sub-block 642, the block 640 may optionally include generating a plurality of training sets, each training set including a feature vector of a difference in magnitude between the first set of transfer functions 212 and the second set of transfer functions 214 and a label of the current occupied condition X. In some implementations, each set of transfer functions is further associated with a current temperature and the feature vector further includes the current temperature. In some implementations, the feature vector includes a difference in magnitude between corresponding pairs of the first set of transfer functions 212 and the second set of transfer functions 214 at a plurality of frequencies within an analyzed frequency band. For example, analyzed frequency band may be approximately 250 Hz-12 kHz with a frequency resolution of 50-150 Hz.

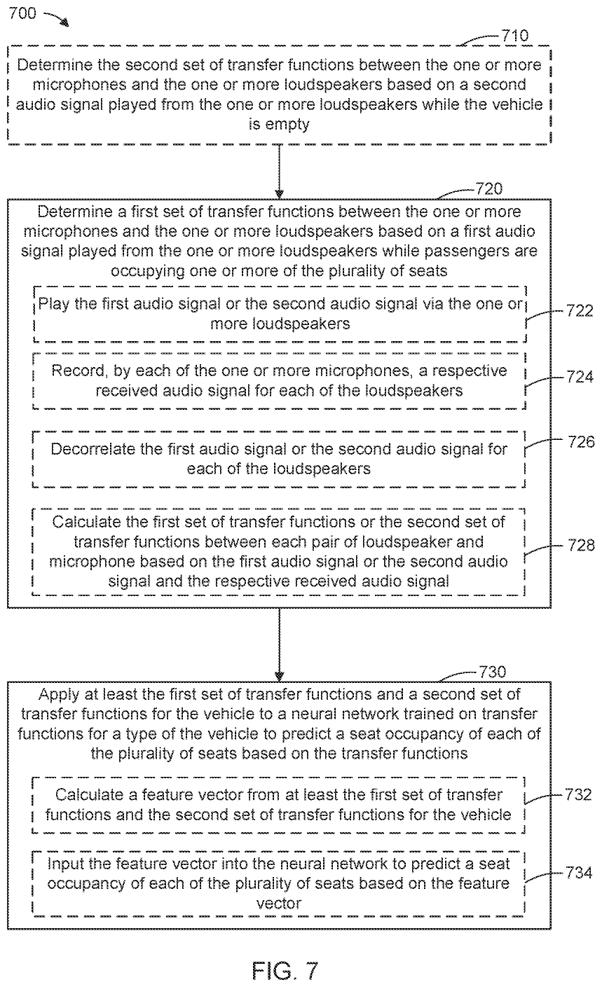

FIG. 7 is a flowchart of an example method 700 of detecting vehicle occupancy. The method 700 may be performed by a vehicle 100 including a vehicle occupancy detection component 120. The vehicle 100 also includes the plurality of seats 130, one or more loudspeakers 140, and one or more microphones 150. The vehicle 100 may optionally include the thermometer 160.

In block 710, the method 700 optionally includes determining a second set of transfer functions between the one or more microphones and the one or more loudspeakers based on a second audio signal played from the one or more loudspeakers while the vehicle is empty. In some implementations, for example, the audio signal processing unit 110 and/or the transfer function calculator 210 may determine the second set of transfer functions 214 between the one or more microphones 150 and the one or more loudspeakers 140 based on a second audio signal played from the one or more loudspeakers while the vehicle 100 is empty.

In block 720, the method 700 includes determining a first set of transfer functions between the one or more microphones and the one or more loudspeakers based on a first audio signal played from the one or more loudspeakers while passengers are occupying one or more of the plurality of seats. In an implementations, for example, the audio signal processing unit 110 and/or the transfer function calculator 210 may determine the first set of transfer functions 212 between the one or more microphones 150 and the one or more loudspeakers 140 based on a first audio signal played from the one or more loudspeakers 140 while passengers are occupying one or more of the plurality of seats 130.

In some implementations, at sub-block 722, the block 720 (or block 710) optionally includes playing the first audio signal or the second audio signal (L) via the one or more loudspeakers 140. For example, the audio signal processing unit 110 may output a signal L1 . . . Ln to play a segment of the first audio signal or the second audio signal from each loudspeaker 140 individually. In some implementations, at sub-block 726, the block 720 (or block 710 or sub-block 722) optionally includes decorrelating the first audio signal or the second audio signal for each of the loudspeakers. For example, sub-block 726 may be performed when multiple loudspeakers 140 play the audio signal at the same time to generate separate audio signals for each loudspeaker 140. In some implementations, the first audio signal may be played in response to the vehicle being loaded, for example, when the vehicle 100 starts to move. In some implementations, the second audio signal may be played when the vehicle is empty in response to the vehicle 100 being unlocked. In some implementations, the first audio signal or the second audio signal is a preconfigured chime that spans an analyzed frequency band. In some implementations, the first audio signal is an output from an entertainment system such as music or speech.

At sub-block 724, the block 720 (or block 710) optionally includes recording, by each of the one or more microphones 150, a respective received audio signal (M) for each of the loudspeakers. At sub-block 728, the block 720 (or block 710) optionally includes calculating the first set of transfer functions 212 or the second set of transfer functions 214 between each pair of loudspeaker 140 and microphone 150 based on the first audio signal or the second audio signal and the respective received audio signal.

In block 730, the method 700 includes applying at least the first set of transfer functions and a second set of transfer functions for the vehicle to a neural network trained on transfer functions for a type of the vehicle to predict a seat occupancy of each of the plurality of seats based on the feature vector. In some implementations, for example, the audio signal processing unit 110 and/or the feature vector generator 220 applies at least the first set of transfer functions 212 and a second set of transfer functions 214 for the vehicle 100 to the artificial neural network 230 trained on transfer functions for a type of the vehicle to predict a seat occupancy 240 of each of the plurality of seats 130 based on the transfer functions.

In some implementations, at sub-block 732, the block 730 optionally includes calculating a feature vector F 222 from at least the first set of transfer functions 212 and the second set of transfer functions 214 for the vehicle 100. In some implementations, the feature vector includes a current temperature. In some implementations, the sub-block 732 includes, determining a difference in magnitude between corresponding pairs of the first set of transfer functions 212 and the second set of transfer functions 214 at a plurality of frequencies within an analyzed frequency band. For instance, the analyzed frequency band may be approximately 250 Hz-12 kHz with a frequency resolution of 50-150 Hz. In some implementations, at sub-block 734, the block 730 optionally includes inputting the feature vector F 222 into the artificial neural network 230 to predict the seat occupancy 240 of each of the plurality of seats 130 based on the feature vector F 222. For instance, in some implementations, the artificial neural network 230 is configured to output the seat occupancy 240 as an estimate of a size of a person occupying each of the plurality of seats (e.g., as a value between 0 and 1). The seat occupancy 240 may be output to another vehicle system such as a safety system for collision mitigation or child reminders.

Numerous other aspects emerge from the foregoing detailed description and annexed drawings. Those aspects are represented by the following Clauses.

Clause 1. A method of detecting seat occupancy of a vehicle including a plurality of seats, one or more microphones, and one or more loudspeakers, comprising: determining a first set of transfer functions between the one or more microphones and the one or more loudspeakers based on a first audio signal played from the one or more loudspeakers while passengers are occupying one or more of the plurality of seats; and applying at least the first set of transfer functions and a second set of transfer functions for the vehicle to a neural network trained on transfer functions for a type of the vehicle to predict a seat occupancy of each of the plurality of seats based on the transfer functions.

Clause 2. The method of clause 1, further comprising: determining the second set of transfer functions between the one or more microphones and the one or more loudspeakers based on a second audio signal played from the one or more loudspeakers while the vehicle is empty.

Clause 3. The method of clause 2, wherein determining the first set of transfer functions or the second set of transfer functions comprises: playing the first audio signal or the second audio signal via the one or more loudspeakers; recording, by each of the one or more microphones, a respective received audio signal for each of the loudspeakers; and calculating the first set of transfer functions or the second set of transfer functions between each pair of loudspeaker and microphone based on the first audio signal or the second audio signal and the respective received audio signal.

Clause 4. The method of clause 3, wherein playing the first audio signal or the second audio signal via the one or more loudspeakers comprises playing a segment of the first audio signal or the second audio signal from each loudspeaker individually.

Clause 5. The method of clause 3, wherein playing the first audio signal or the second audio signal via the one or more loudspeakers comprises decorrelating the first audio signal or the second audio signal for each of the loudspeakers.

Clause 6. The method of any of clauses 2-5, wherein the second audio signal played from the one or more loudspeakers while the vehicle is empty is played in response to the vehicle being unlocked.

Clause 7. The method of any clauses 1-6, wherein applying at least the first set of transfer functions and the second set of transfer functions for the vehicle to the neural network, comprises: calculating a feature vector from at least the first set of transfer functions and the second set of transfer functions for the vehicle; and inputting the feature vector into the neural network to predict a seat occupancy of each of the plurality of seats based on the feature vector.

Clause 8. The method of clause 7, wherein the feature vector further includes a current temperature.

Clause 9. The method of clause 7 or 8, wherein calculating the feature vector comprises determining a difference in magnitude between corresponding pairs of the first set of transfer functions and the second set of transfer functions at a plurality of frequencies within an analyzed frequency band.

Clause 10. The method of clause 9, wherein the analyzed frequency band is approximately 250 Hz-12 kHz with a frequency resolution of 50-150 Hz.

Clause 11. The method of any of clauses 1-10, wherein the neural network is configured to output an estimate of a size of a person occupying each of the plurality of seats.

Clause 12. The method of any of clauses 1-11, wherein the first audio signal is a preconfigured chime that spans an analyzed frequency band.

Clause 13. The method of any of clauses 1-11, wherein the first audio signal is an output from an entertainment system.

Clause 14. A method of training a neural network to detect vehicle occupancy of a vehicle including a plurality of seats, one or more microphones, and one or more loudspeakers, comprising: playing, in the vehicle, an audio signal via the one or more loudspeakers while the plurality of seats are in each occupied condition of a plurality of occupied conditions including an empty-vehicle condition; recording, by the one or more microphones, a respective received audio signal for each of the one or more loudspeakers for each occupied condition; calculating a set of transfer functions between each pair of loudspeaker and microphone for each occupied condition; and training a neural network to predict an occupancy for each of the plurality of seats based on a first set of transfer functions for the empty-vehicle condition and a second set of transfer functions for a current occupied condition.

Clause 15. The method of clause 14, wherein playing the audio signal via the one or more loudspeakers comprises playing a segment of the audio signal from each loudspeaker individually.

Clause 16. The method of clause 14, wherein training the neural network comprises generating a plurality of training sets, each training set including a feature vector of a difference in magnitude between the first set of transfer functions and the second set of transfer functions and a label of the current occupied condition.

Clause 17. The method of clause 16, wherein each set of transfer functions is further associated with a current temperature and the feature vector further includes the current temperature.

Clause 18. The method of clause 16 or 17, wherein the feature vector comprises a difference in magnitude between corresponding pairs of the first set of transfer functions and the second set of transfer functions at a plurality of frequencies within an analyzed frequency band.

Clause 19. The method of clause 18, wherein the analyzed frequency band is approximately 250 Hz-12 kHz with a frequency resolution of 50-150 Hz.

Clause 20. The method of any of clauses 14-19, wherein the neural network is configured to output an estimate of a size of a person occupying each of the plurality of seats.

Clause 21. An apparatus for detecting seat occupancy of a vehicle including a plurality of seats, one or more microphones, and one or more loudspeakers, comprising: a memory storing computer-executable instructions; and a digital signal processor coupled to the memory and configured to execute the instructions to: determine a first set of transfer functions between the one or more microphones and the one or more loudspeakers based on a first audio signal played from the one or more loudspeakers while passengers are occupying one or more of the plurality of seats; and apply at least the first set of transfer functions and a second set of transfer functions for the vehicle to a neural network trained on transfer functions for a type of the vehicle to predict a seat occupancy of each of the plurality of seats based on the feature vector.

Clause 22. The apparatus of clause 21, wherein the digital signal processor is configured to: determine the second set of transfer functions between the one or more microphones and the one or more loudspeakers based on a second audio signal played from the one or more loudspeakers while the vehicle is empty.

Clause 23. The apparatus of clause 22, wherein to determine the first set of transfer functions or the second set of transfer functions, the digital signal processor is configured to: output, to the one or more loudspeakers, the first audio signal or the second audio signal via the one or more loudspeakers; receive, from each of the one or more microphones, a respective received audio signal for each of the loudspeakers; and calculate the first set of transfer functions or the second set of transfer functions between each pair of loudspeaker and microphone based on the first audio signal or the second audio signal and the respective received audio signal.

Clause 24. The apparatus of clause 23, wherein to output the first audio signal or the second audio signal via the one or more loudspeakers, the digital signal processor is configured to output a segment of the first audio signal or the second audio signal to each loudspeaker individually.

Clause 25. The apparatus of clause 23, wherein to output the first audio signal or the second audio signal via the one or more loudspeakers, the digital signal processor is configured to decorrelate the first audio signal or the second audio signal for each of the loudspeakers.

Clause 26. The apparatus of any of clauses 22-25, wherein the digital signal processor is configured to output the second audio signal to the one or more loudspeakers while the vehicle is empty in response to the vehicle being unlocked.

Clause 27. The apparatus of any of clauses 21-26, wherein to apply at least the first set of transfer functions and the second set of transfer functions for the vehicle to the neural network, the digital signal processor is configured to: calculate a feature vector from at least the first set of transfer functions and the second set of transfer functions for the vehicle; and input the feature vector into the neural network to predict a seat occupancy of each of the plurality of seats based on the feature vector.

Clause 28. The apparatus of clause 27, wherein the feature vector further includes a current temperature.

Clause 29. The apparatus of clause 27 or 28, wherein to calculate the feature vector, the digital signal processor is configured to determine a difference in magnitude between corresponding pairs of the first set of transfer functions and the second set of transfer functions at a plurality of frequencies within an analyzed frequency band.

Clause 30. The apparatus of clause 29, wherein the analyzed frequency band is approximately 250 Hz-12 kHz with a frequency resolution of 50-150 Hz.

Clause 31. The apparatus of any of clauses 21-30, wherein the neural network is configured to output an estimate of a size of a person occupying each of the plurality of seats.

Clause 32. The apparatus of any of clauses 21-31, wherein the first audio signal is a preconfigured chime that spans an analyzed frequency band.

Clause 33. The apparatus of any of clauses 21-31, wherein the first audio signal is an output via an entertainment system.

Clause 34. A vehicle comprising the apparatus of any of clauses 21-33, the vehicle further comprising: the plurality of seats; the one or more microphones; and the one or more loudspeakers.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, scripts, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer-readable media excludes transitory signals.

1. A method of detecting seat occupancy of a vehicle including a plurality of seats, one or more microphones, and one or more loudspeakers, comprising:
determining a first set of transfer functions between the one or more microphones and the one or more loudspeakers based on a first audio signal played from the one or more loudspeakers while passengers are occupying one or more of the plurality of seats; and
applying at least the first set of transfer functions and a second set of transfer functions for the vehicle to a neural network trained on transfer functions for a type of the vehicle to predict a seat occupancy of each of the plurality of seats based on the transfer functions.

2. The method of claim 1, further comprising:
determining the second set of transfer functions between the one or more microphones and the one or more loudspeakers based on a second audio signal played from the one or more loudspeakers while the vehicle is empty.

3. The method of claim 2, wherein determining the first set of transfer functions or the second set of transfer functions comprises:
playing the first audio signal or the second audio signal via the one or more loudspeakers;
recording, by each of the one or more microphones, a respective received audio signal for each of the loudspeakers; and
calculating the first set of transfer functions or the second set of transfer functions between each pair of loudspeaker and microphone based on the first audio signal or the second audio signal and the respective received audio signal.

4. The method of claim 3, wherein playing the first audio signal or the second audio signal via the one or more loudspeakers comprises playing a segment of the first audio signal or the second audio signal from each loudspeaker individually.

5. The method of claim 3, wherein playing the first audio signal or the second audio signal via the one or more loudspeakers comprises decorrelating the first audio signal or the second audio signal for each of the loudspeakers.

6. The method of claim 2, wherein the second audio signal played from the one or more loudspeakers while the vehicle is empty is played in response to the vehicle being unlocked.

7. The method of claim 1, wherein applying at least the first set of transfer functions and the second set of transfer functions for the vehicle to the neural network, comprises:
calculating a feature vector from at least the first set of transfer functions and the second set of transfer functions for the vehicle; and
inputting the feature vector into the neural network to predict a seat occupancy of each of the plurality of seats based on the feature vector.

8. The method of claim 7, wherein the feature vector further includes a current temperature.

9. The method of claim 7, wherein calculating the feature vector comprises determining a difference in magnitude between corresponding pairs of the first set of transfer functions and the second set of transfer functions at a plurality of frequencies within an analyzed frequency band.

10. The method of claim 9, wherein the analyzed frequency band is approximately 250 Hz-12 kHz with a frequency resolution of 50-150 Hz.

11. The method of claim 1, wherein the neural network is configured to output an estimate of a size of a person occupying each of the plurality of seats.

12. The method of claim 1, wherein the first audio signal is a preconfigured chime that spans an analyzed frequency band.

13. The method of claim 1, wherein the first audio signal is an output from an entertainment system.

14. A method of training a neural network to detect vehicle occupancy of a vehicle including a plurality of seats, one or more microphones, and one or more loudspeakers, comprising:
playing, in the vehicle, an audio signal via the one or more loudspeakers while the plurality of seats are in each occupied condition of a plurality of occupied conditions including an empty-vehicle condition;
recording, by the one or more microphones, a respective received audio signal for each of the one or more loudspeakers for each occupied condition;
calculating a set of transfer functions between each pair of loudspeaker and microphone for each occupied condition; and
training a neural network to predict an occupancy for each of the plurality of seats based on a first set of transfer functions for the empty-vehicle condition and a second set of transfer functions for a current occupied condition.

15. The method of claim 14, wherein playing the audio signal via the one or more loudspeakers comprises playing a segment of the audio signal from each loudspeaker individually.

16. The method of claim 14, wherein training the neural network comprises generating a plurality of training sets, each training set including a feature vector of a difference in magnitude between the first set of transfer functions and the second set of transfer functions and a label of the current occupied condition.

17. The method of claim 16, wherein each set of transfer functions is further associated with a current temperature and the feature vector further includes the current temperature.

18. The method of claim 16, wherein the feature vector comprises a difference in magnitude between corresponding pairs of the first set of transfer functions and the second set of transfer functions at a plurality of frequencies within an analyzed frequency band.

19. The method of claim 18, wherein the analyzed frequency band is approximately 250 Hz-12 kHz with a frequency resolution of 50-150 Hz.

20. The method of claim 14, wherein the neural network is configured to output an estimate of a size of a person occupying each of the plurality of seats.

21. An apparatus for detecting seat occupancy of a vehicle including a plurality of seats, one or more microphones, and one or more loudspeakers, comprising:
a memory storing computer-executable instructions; and
a digital signal processor coupled to the memory and configured to execute the instructions to:
determine a first set of transfer functions between the one or more microphones and the one or more loudspeakers based on a first audio signal played from the one or more loudspeakers while passengers are occupying one or more of the plurality of seats; and
apply at least the first set of transfer functions and a second set of transfer functions for the vehicle to a neural network trained on transfer functions for a type of the vehicle to predict a seat occupancy of each of the plurality of seats based on the transfer functions.

22. The apparatus of claim 21, wherein the digital signal processor is configured to:
determine the second set of transfer functions between the one or more microphones and the one or more loudspeakers based on a second audio signal played from the one or more loudspeakers while the vehicle is empty.

23. The apparatus of claim 22, wherein to determine the first set of transfer functions or the second set of transfer functions, the digital signal processor is configured to:
output, to the one or more loudspeakers, the first audio signal or the second audio signal via the one or more loudspeakers;
receive, from each of the one or more microphones, a respective received audio signal for each of the loudspeakers; and
calculate the first set of transfer functions or the second set of transfer functions between each pair of loudspeaker and microphone based on the first audio signal or the second audio signal and the respective received audio signal.

24. The apparatus of claim 23, wherein to output the first audio signal or the second audio signal via the one or more loudspeakers, the digital signal processor is configured to output a segment of the first audio signal or the second audio signal to each loudspeaker individually.

25. The apparatus of claim 23, wherein to output the first audio signal or the second audio signal via the one or more loudspeakers, the digital signal processor is configured to decorrelate the first audio signal or the second audio signal for each of the loudspeakers.

26. The apparatus of claim 22, wherein the digital signal processor is configured to output the second audio signal to the one or more loudspeakers while the vehicle is empty in response to the vehicle being unlocked.

27. The apparatus of claim 21, wherein to apply at least the first set of transfer functions and the second set of transfer functions for the vehicle to the neural network, the digital signal processor is configured to:
calculate a feature vector from at least the first set of transfer functions and the second set of transfer functions for the vehicle; and
input the feature vector into the neural network to predict a seat occupancy of each of the plurality of seats based on the feature vector.

28. The apparatus of claim 27, wherein the feature vector further includes a current temperature.

29. The apparatus of claim 27, wherein to calculate the feature vector, the digital signal processor is configured to determine a difference in magnitude between corresponding pairs of the first set of transfer functions and the second set of transfer functions at a plurality of frequencies within an analyzed frequency band.

30. The apparatus of claim 29, wherein the analyzed frequency band is approximately 250 Hz-12 kHz with a frequency resolution of 50-150 Hz.

31. The apparatus of claim 21, wherein the neural network is configured to output an estimate of a size of a person occupying each of the plurality of seats.

32. The apparatus of claim 21, wherein the first audio signal is a preconfigured chime that spans an analyzed frequency band.

33. The apparatus of claim 21, wherein the first audio signal is an output via an entertainment system.

34. A vehicle comprising the apparatus of claim 21, the vehicle further comprising:
the plurality of seats;
the one or more microphones; and
the one or more loudspeakers.
